(19) United States
(12) Patent Application Publication
(10) Pub. No.: US 2025/0166411 A1
(43) Pub. Date: May 22, 2025

(54) DEEPFAKE DETECTION METHOD BASED ON IDENTITY AND FACE SHAPE FEATURES

(71) Applicants: Qilu University of Technology (Shandong Academy of Sciences), Jinan (CN); SHANDONG COMPUTER SCIENCE CENTER (NATIONAL SUPERCOMPUTING CENTER IN JINAN), Jinan (CN); Shandong Artificial Intelligence Institute, Jinan (CN)

(72) Inventors: Minglei SHU, Jinan (CN); Haoran LI, Jinan (CN); Pengyao XU, Jinan (CN); Shuwang ZHOU, Jinan (CN); Zhaoyang LIU, Jinan (CN); Zhe ZHU, Jinan (CN)

(73) Assignees: Qilu University of Technology (Shandong Academy of Sciences), Jinan (CN); SHANDONG COMPUTER SCIENCE CENTER (NATIONAL SUPERCOMPUTING CENTER IN JINAN), Jinan (CN); Shandong Artificial Intelligence Institute, Jinan (CN)

(21) Appl. No.: 18/749,670

(22) Filed: Jun. 21, 2024

(30) Foreign Application Priority Data
Nov. 20, 2023 (CN) 202311546911X

(51) Int. Cl. G06V 40/16

(52) U.S. Cl. CPC G06V 40/168; G06V 40/172

(57) ABSTRACT

A Deepfake detection method based on identity and face shape features is provided. The Deepfake detection method combines an identity feature with a three-dimensional (3D) face shape feature, and designs a face shape consistency self-attention (FSCA) module and an identity guided shape consistency attention (IGSCA) module to mine an identity and face shape inconsistency feature. The Deepfake detection method achieves strong targeting performance based on reference face information of different faces, and additionally utilizes a reference face to assist in detecting a target face, achieving strong targeting performance. The Deepfake detection method combines identity and shape features to achieve good generalized detection performance, improving Deepfake detection performance and accuracy.

### CROSS-REFERENCE TO THE RELATED APPLICATIONS

This application is based upon and claims priority to Chinese Patent Application No. 202311546911.X, filed on Nov. 20, 2023, the entire contents of which are incorporated herein by reference.

### TECHNICAL FIELD

The present disclosure relates to the technical field of Deepfake detection, and in particular to a Deepfake detection method based on identity and face shape features.

### BACKGROUND

In recent years, with the continuous development of Deepfake technology, even the general public can change the identity of images through some open-source methods, making it hard for ordinary people to distinguish authenticity. The Deepfake technology can be used for entertainment and film and television production projects, etc., but it can also be used for illegal purposes such as malicious dissemination and online fraud, causing negative effects.

Traditional Deepfake detection methods directly consider the problem of Deepfake detection as a binary classification problem, and directly classify real and fake images through backbone networks, with average detection performance. Later methods often capture forged traces left by the generator through carefully designed modules, resulting in poor generalization performance. In practical applications, the detection performance of model fitting and specific methods for the faces that are generated by unknown faking methods sharply decreases.

### SUMMARY

In order to overcome the above-mentioned shortcomings in the prior art, the present disclosure provides a Deepfake detection method based on identity and face shape features, which achieves strong targeting performance for face detection.

In order to solve the technical problem, the present disclosure adopts the following technical solution.

The Deepfake detection method based on identity and face shape features includes the following steps:
a) acquiring videos to form a training set and a test set, extracting a tensor Xₜᵣₐᵢₙ from the training set, and extracting tensors X′ₜₑₛₜ and X′_{ref} from the test set;
b) inputting the tensor Xₜᵣₐᵢₙ into an identity encoder to acquire a facial identity feature F_{id}ⁿ;
c) constructing an identity feature consistency network, including a three-dimensional (3D) reconstruction encoder, an identity and face shape consistency extraction network, and a fusion unit;
d) inputting the tensor Xₜᵣₐᵢₙ into the 3D reconstruction encoder of the identity feature consistency network to acquire a face shape feature Fₛₕₐₚₑ
e) inputting the feature Fₛₕₐₚₑ and the facial identity feature F_{id}ⁿ into the identity and face shape consistency extraction network of the identity feature consistency network to acquire an identity and face shape consistency feature F_{ISC}
f) inputting the facial identity feature F_{id}ⁿ and the identity and face shape consistency feature F_{ISC} into the fusion unit of the identity feature consistency network for fusing to acquire a feature F_{IC};
g) calculating a loss function L, and training the identity feature consistency network through the loss function L to acquire an optimized identity feature consistency network; and
h) inputting the tensor X′ₜₑₛₜ into the optimized identity feature consistency network test to acquire a feature F′_{IC}; inputting X′_{ref} into the optimized identity feature consistency network to acquire a feature F″_{IC}; and calculating a similarity value S by s=δ(F′_{IC}, F″_{IC}), where δ(·,·) denotes a cosine similarity calculation function; determining that a face in a video is a real face if the similarity value S is greater than or equal to a threshold τ; and determining that the face in the video is a fake face if the similarity value S is less than τ.

Further, the step a) includes:
a-1) acquiring, from a facial forgery dataset FaceForensics++, N videos as the training set Vₜᵣₐᵢₙ and M videos as the test set Vₜₑₛₜ, where Vₜᵣₐᵢₙ=V_{F}+V_{R}={V₁,V₂, . . . ,Vₙ, . . . ,V_{N}; the trainingset includes N_{F} fakevideos and N_{R} real videos, N_{F}+N_{R}=N; V_{F} denotes a fake video set, and V_{R} denotes a real video set; Vₙ denotes an n-th video,n∈{1, . . . , N}; the n-th video V includes L image frames, Vₙ=x₁, x₂, . . . , xⱼ, . . . , x_{L}}; Xᵢ denotes a j-th image frame,j∈{1, . . . ,L}, and Xⱼ corresponds to a class label yⱼ^{s}; when the j-th image frame Xⱼ is a real image, Xⱼ is 0; when the j-th image frame xⱼ is a fake image, X₁ is 1; the j-th image frame Xⱼ corresponds to a source identity label yⱼ^{s}; Vₜₑₛₜ=V_{F}′+V_{R}′ ={V₁′,V₂′, . . . , Vₘ′, . . . , V_{M}′}; the test set includes M_{F} fake videos and M_{R} real videos, M_{F}+M_{R}=M; V_{F}′ denotes a fake video set, and V_{R}′ denotes a real video set; and Vₘ′ denotes an m-th video,m∈{1, . . . , M};
a-2) reading, by VideoReader in opencv, the n-th video Vₙ in the training set frame by frame; randomly extracting T consecutive video frames from the n-th video Vₙ as a training video Vₜᵣₐᵢₙ; detecting, by a multi-task cascaded convolutional network (MTCNN) algorithm, a facial keypoint in each video frame of the training video Vₜᵣₐᵢₙ, and calibrating a facial image; and cutting a calibrated facial image to form a facial image matrix Xₜᵣₐᵢₙ′;
a-3) reading, by VideoReader in opencv, the m-th video Vₘ′ of the fake video set V_{F}′ in the test set frame by frame; and randomly extracting T consecutive video frames from the m-th video Vₘ′ as a test video V_{test_1}; reading, by VideoReader in opency, the m-th video Vₘ′ of the real video set V_{R}′ in the test set frame by frame; randomly extracting two sets of T consecutive video frames from the m-th video Vₘ′, where a first set of consecutive video frames forms a test video V_{test_2} and a second set of consecutive video frames forms a reference video V_{ref}; acquiring a test video Vₜₑₛₜ by Vₜₑₛₜ=V_{test_1}+V_{test_2}; detecting, by the MTCNN algorithm, a facial keypoint in each video frame of the test video Vₜₑₛₜ, and calibrating a facial image; cutting a calibrated facial image to form a facial image matrix Xₜₑₛₜ′; detecting, by the MTCNN algorithm, a facial keypoint in each video frame of the reference video V_{ref}, and calibrating a facial image; and cutting a calibrated facial image to form a facial image matrix X_{ref}′; and
a-4) transposing, by a ToTensor( ) function in PyTorch, the facial image matrix Xₜᵣₐᵢₙ′ into the tensor Xₜᵣₐᵢₙ, Xₜᵣₐᵢₙ∈R^{T×C×H×W}, transposing the facial image matrix Xₜₑₛₜ′into the tensor Xₜₑₛₜ, Xₜₑₛₜ∈R^{T×C×H×W}, and transposing the facial image matrix X_{ref}′into the tensor X_{ref},X_{ref}∈R^{T×C×H×W}where R denotes a real number space, C denotes a channel number of the image frame, H denotes a height of the image frame, and W denotes a width of the image frame.

Further, the step b) includes: constructing the identity encoder, including an additive angular margin loss (ArcFace) face recognition model; inputting the tensor Xₜᵣₐᵢₙ into the identity encoder to acquire an identity feature F_{id}′ of the n-th video Vₙ in the training set, F_{id}′ ∈R^{T×512}; and transposing, by a tensor.transpose( ) function in PyTorch, the identity feature F_{id}′ into the facial identity feature F_{id}ⁿ, of the n-th video Vₙ in the training set, F_{id}ⁿ∈ R^{512×T}, n ∈{1, . . . , N}.

Further, the step d) includes:
d-1) constructing the 3D reconstruction encoder of the identity feature consistency network, including a pre-trained Deep3DFaceRecon network;
d-2) inputting the tensor Xₜᵣₐᵢₙ into the 3D reconstruction encoder to acquire a 3D morphable model (3DMM) identity feature Fₛₕₐₚₑ; and
d-3) transposing, by the tensor.transpose( ) function in PyTorch, the 3DMM identity feature Fₛₕₐₚₑ′ into the face shape feature Fₛₕₐₚₑ, Fₛₕₐₚₑ∈R^{257×T}.

Further, the step e) includes:
e-1) constructing the identity and face shape consistency extraction network of the identity feature consistency network, including a face shape consistency self-attention (FSCA) module and an identity guided shape consistency attention (IGSCA) module;
e-2) constructing the FSCA module of the identity and face shape consistency extraction network, including a temporal convolutional block, a first residual convolutional block, a second residual convolutional block, a third residual convolutional block, a first self-attention block, a second self-attention block, a third self-attention block, and a fourth self-attention block;
e-3) constructing the temporal convolutional block of the FSCA module, including a one-dimensional (1D) convolutional layer, a layer normalization (LayerNorm) layer, and a leaky rectified linear unit (LeakeyReLU) function; inputting the face shape feature Fₛₕₐₚₑ into the 1D convolutional layer to acquire a feature Fₛₕₐₚₑ¹⁻¹;inputting the feature Fₛₕₐₚₑ¹⁻¹ into the LayerNorm layer to acquire a feature Fₛₕₐₚₑ¹⁻²; and inputting the feature Fₛₕₐₚₑ¹⁻² into the LeakeyReLU function to acquire a feature Fₛₕₐₚₑ¹, Fₛₕₐₚₑ¹ ∈R^{512×T};
e-4) constructing the first residual convolutional block, the second residual convolutional block, and the third residual convolutional block of the FSCA module, each including a ID convolutional layer, a LayerNorm layer, and a LeakeyReLU function; inputting the feature Fₛₕₐₚₑ¹ into the 1D convolutional layer of the first residual convolutional block to acquire a feature Fₛₕₐₚₑ²⁻¹, inputting the feature Fₛₕₐₚₑ²⁻¹ into the LayerNorm layer of the first residual convolutional block to acquire a feature Fₛₕₐₚₑ²⁻², inputting the feature Fₛₕₐₚₑ²⁻² into the LeakeyReLU function of the first residual convolutional block to acquire a feature Fₛₕₐₚₑ²⁻³, and adding the feature Fₛₕₐₚₑ¹ to the feature Fₛₕₐₚₑ²⁻³ to acquire a feature Fₛₕₐₚₑ²; inputting the feature Fₛₕₐₚₑ² into the 1D convolutional layer of the second residual convolutional block to acquire a feature Fₛₕₐₚₑ³⁻¹, inputting the feature Fₛₕₐₚₑ³⁻¹ into the LayerNorm layer of the second residual convolutional block to acquire a feature Fₛₕₐₚₑ³⁻², inputting the feature Fₛₕₐₚₑ³⁻² into the LeakeyReLU function of the second residual convolutional block to acquire a feature Fₛₕₐₚₑ³⁻³, and adding the feature Fₛₕₐₚₑ² to the feature Fₛₕₐₚₑ³⁻³ to acquire a feature Fₛₕₐₚₑ³; and inputting the feature Fₛₕₐₚₑ³ into the 1D convolutional layer of the third residual convolutional block to acquire a feature Fₛₕₐₚₑ⁴⁻¹, inputting the feature Fₛₕₐₚₑ⁴⁻¹ into the LayerNorm layer of the third residual convolutional block to acquire a feature Fₛₕₐₚₑ⁴⁻², inputting the feature Fₛₕₐₚₑ⁴⁻² into the LeakeyReLU function of the third residual convolutional block to acquire a feature Fₛₕₐₚₑ⁴⁻³ and adding the feature Fₛₕₐₚₑ³ to the feature Fₛₕₐₚₑ⁴⁻³ to acquire a feature Fₛₕₐₚₑ⁴;
e-5) constructing the first self-attention block, the second self-attention block, the third self-attention block, and the fourth self-attention block of the FSCA module, each including a multi-head attention mechanism and a LayerNorm layer; transposing, by the tensor.transpose( ) function in PyTorch, the feature Fₛₕₐₚₑ⁴ into a feature Fₛₕₐₚₑ⁴′ Fₛₕₐₚₑ⁴′,∈R^{T×512}; inputting the feature Fₛₕₐₚₑ⁴′ into the multi-head attention mechanism of the first self-attention block to acquire a feature Fₛₕₐₚₑ⁵⁻¹, inputting the feature Fₛₕₐₚₑ⁵⁻¹ into the LayerNorm layer of the first self-attention block to acquire a feature Fₛₕₐₚₑ⁵⁻¹′, and adding the feature Fₛₕₐₚₑ⁵⁻¹′ to the feature Fₛₕₐₚₑ⁴′ to acquire a feature Fₛₕₐₚₑ⁵; inputting the feature Fₛₕₐₚₑ⁵ into the multi-head attention mechanism of the second self-attention block to acquire a feature Fₛₕₐₚₑ⁶⁻¹, inputting the feature Fₛₕₐₚₑ⁶⁻¹ into the LayerNorm layer of the second self-attention block to acquire a feature Fₛₕₐₚₑ⁶⁻¹′ and adding the feature Fₛₕₐₚₑ⁶⁻¹′ to the feature Fₛₕₐₚₑ⁶ to acquire a feature Fₛₕₐₚₑ⁶; inputting the feature Fₛₕₐₚₑ⁶ into the multi-head attention mechanism of the third self-attention block to acquire a feature Fₛₕₐₚₑ⁷⁻¹, inputting the feature Fₛₕₐₚₑ⁷⁻¹ into the LayerNorm layer of the third self-attention block to acquire a feature Fₛₕₐₚₑ⁷⁻¹′, and adding the feature Fₛₕₐₚₑ⁷⁻¹′ to the feature Fₛₕₐₚₑ⁶ to acquire a feature Fₛₕₐₚₑ⁷; and inputting the feature Fₛₕₐₚₑ⁷ into the multi-head attention mechanism of the fourth self-attention block to acquire a feature Fₛₕₐₚₑ⁸⁻¹, inputting the feature Fₛₕₐₚₑ⁸⁻¹ into the LayerNorm layer of the fourth self-attention block to acquire a feature Fₛₕₐₚₑ⁸⁻¹′, and adding the feature Fₛₕₐₚₑ⁸⁻¹′ to the feature Fₛₕₐₚₑ⁷ to acquire a feature Fₛₕₐₚₑ⁸, Fₛₕₐₚₑ⁸∈R^{T×512}
e-6) constructing the IGSCA module of the identity feature consistency network, including an identity feature mapping block, a first cross attention block (CAB), a second CAB, a third CAB, a fourth CAB, a first dilated convolutional block, a second dilated convolutional block, a third dilated convolutional block, a fourth dilated convolutional block, and a fifth dilated convolutional block;
e-7) constructing the identity feature mapping block of the IGSCA module, including a ID convolutional layer, a LayerNorm layer, and a LeakeyReLU function; inputting the facial identity feature F_{id}ⁿ into the ID convolutional layer of the identity feature mapping block to acquire a feature F_{id}¹⁻¹; inputting the feature F_{id}¹⁻¹ into the LayerNorm layer of the identity feature mapping block to acquire a feature F_{id}¹⁻²; inputting the feature F_{id}¹⁻² into the LeakeyReLU function of the identity feature mapping block to acquire a feature F_{id}¹⁻³; and transposing, by the tensor.transpose( ) function in PyTorch, the feature F_{id}¹⁻³ into a feature F_{id}¹, F_{id}¹ ∈R^{T×512}
e-8) constructing the first CAB, the second CAB, the third CAB, and the fourth CAB of the IGSCA module, each including a multi-head attention mechanism, a LayerNorm layer, and a LeakeyReLU function; performing a linear transformation on the feature F_{id}¹ to acquire a value of query in the multi-head attention mechanism of the first CAB; performing a linear transformation on the feature Fₛₕₐₚₑ⁸ to acquire values of key and value in the multi-head attention mechanism of the first CAB, thereby acquiring an output feature Fₛₕₐₚₑ⁹⁻¹ of the multi-head attention mechanism in the first CAB; inputting the feature Fₛₕₐₚₑ⁹⁻¹ into the LayerNorm layer of the first CAB to acquire a feature Fₛₕₐₚₑ⁹⁻¹′; adding the feature Fₛₕₐₚₑ⁹⁻¹′ to the feature Fₛₕₐₚₑ⁸ to acquire a feature Fₛₕₐₚₑ⁹; performing a linear transformation on the feature F_{id}¹ to acquire a value of query in the multi-head attention mechanism of the second CAB; performing a linear transformation on the feature Fₛₕₐₚₑ⁹ to acquire values of key and value in the multi-head attention mechanism of the second CAB, thereby acquiring an output feature Fₛₕₐₚₑ¹⁰⁻¹ of the multi-head attention mechanism in the second CAB; inputting the feature Fₛₕₐₚₑ¹⁰⁻¹ into the LayerNorm layer of the second CAB to acquire a feature Fₛₕₐₚₑ¹⁰⁻¹′; adding the feature Fₛₕₐₚₑ¹⁰⁻¹′ to the feature Fₛₕₐₚₑ⁹, to acquire a feature Fₛₕₐₚₑ¹⁰; performing a linear transformation on the feature F_{id}¹ to acquire a value of query in the multi-head attention mechanism of the third CAB; performing a linear transformation on the feature Fₛₕₐₚₑ¹⁰ to acquire values of key and value in the multi-head attention mechanism of the third CAB, thereby acquiring an output feature Fₛₕₐₚₑ¹¹⁻¹ of the multi-head attention mechanism in the third CAB; inputting the feature Fₛₕₐₚₑ¹¹⁻¹ into the LayerNorm layer of the third CAB to acquire a feature Fₛₕₐₚₑ¹¹⁻¹′; adding the feature Fₛₕₐₚₑ¹¹⁻¹′ to the feature Fₛₕₐₚₑ¹⁰ to acquire a feature Fₛₕₐₚₑ¹¹; performing a linear transformation on the feature F_{id}¹ to acquire a value of query in the multi-head attention mechanism of the fourth CAB; performing a linear transformation on the feature Fₛₕₐₚₑ¹¹ to acquire values of key and value in the multi-head attention mechanism of the fourth CAB, thereby acquiring an output feature Fₛₕₐₚₑ¹²⁻¹ of the multi-head attention mechanism in the fourth CAB; inputting the feature Fₛₕₐₚₑ¹²⁻¹ into the LayerNorm layer of the fourth CAB to acquire a feature Fₛₕₐₚₑ¹²⁻¹′; and adding the feature Fₛₕₐₚₑ¹²⁻¹′ to the feature Fₛₕₐₚₑ¹¹ to acquire a feature Fₛₕₐₚₑ¹²; and
e-9) constructing the first dilated convolutional block, the second dilated convolutional block, the third dilated convolutional block, the fourth dilated convolutional block, and the fifth dilated convolutional block of the IGSCA module, each including a dilated convolutional layer, a group normalization (GroupNorm) layer, and a LeakeyReLU function; inputting the feature Fₛₕₐₚₑ¹² into the dilated convolutional layer of the first dilated shape convolutional block to acquire a feature Fₛₕₐₚₑ¹³⁻¹, inputting the feature Fₛₕₐₚₑ¹³⁻¹ into the GroupNorm layer of the first dilated convolutional block to acquire a feature Fₛₕₐₚₑ¹³⁻², inputting the feature Fₛₕₐₚₑ¹³⁻² into the LeakeyReLU function of the first dilated convolutional block to acquire a feature Fₛₕₐₚₑ¹³⁻²′, and adding the feature Fₛₕₐₚₑ¹³⁻²′ to the feature Fₛₕₐₚₑ¹² to acquire a feature Fₛₕₐₚₑ¹³; inputting the feature Fₛₕₐₚₑ¹³ into the dilated convolutional layer of the second dilated convolutional block to acquire a feature Fₛₕₐₚₑ¹⁴⁻¹, inputting the feature Fₛₕₐₚₑ¹⁴⁻¹ into the GroupNorm layer of the second dilated convolutional block to acquire a feature Fₛₕₐₚₑ¹⁴⁻², inputting the feature Fₛₕₐₚₑ¹⁴⁻² into the LeakeyReLU function of the second dilated convolutional block to acquire a feature Fₛₕₐₚₑ¹⁴⁻²′, and adding the feature Fₛₕₐₚₑ¹⁴⁻²′ to the feature Fₛₕₐₚₑ¹³ to acquire a feature Fₛₕₐₚₑ¹⁴; inputting the feature Fₛₕₐₚₑ¹⁴ into the dilated convolutional layer of the third dilated convolutional block to acquire a feature Fₛₕₐₚₑ¹⁵⁻¹, inputting the feature Fₛₕₐₚₑ¹⁵⁻¹ into the GroupNorm layer of the third dilated convolutional block to acquire a feature Fₛₕₐₚₑ¹⁵⁻², inputting the feature Fₛₕₐₚₑ¹⁵⁻² into the LeakeyReLU function of the third dilated convolutional block to acquire a feature Fₛₕₐₚₑ¹⁵⁻²′, and adding the feature Fₛₕₐₚₑ¹⁵⁻²′ to the feature F to acquire a feature Fₛₕₐₚₑ¹⁵; inputting the feature Fₛₕₐₚₑ¹⁵ into the dilated convolutional layer of the fourth dilated convolutional block to acquire a feature Fₛₕₐₚₑ¹⁶⁻¹ inputting the feature Fₛₕₐₚₑ¹⁶⁻¹ into the GroupNorm layer of the fourth dilated convolutional block to acquire a feature Fₛₕₐₚₑ¹⁶⁻², inputting the feature Fₛₕₐₚₑ¹⁶⁻² into the LeakeyReLU function of the fourth dilated convolutional block to acquire a feature Fₛₕₐₚₑ¹⁶⁻², and adding the feature Fₛₕₐₚₑ¹⁶⁻²′ to the feature Fₛₕₐₚₑ¹⁵ to acquire a feature Fₛₕₐₚₑ¹⁶; and inputting the feature Fₛₕₐₚₑ¹⁶ into the dilated convolutional layer of the fifth dilated shape convolutional block to acquire a feature Fₛₕₐₚₑ¹⁷⁻¹, inputting the feature Fₛₕₐₚₑ¹⁷⁻¹ into the GroupNorm layer of the fifth dilated convolutional block to acquire a feature Fₛₕₐₚₑ¹⁷⁻², inputting the feature Fₛₕₐₚₑ¹⁷⁻² into the LeakeyReLU function of the fifth dilated convolutional block to acquire a feature Fₛₕₐₚₑ¹⁷⁻²′, and adding the feature Fₛₕₐₚₑ¹⁷⁻²′ to the feature Fₛₕₐₚₑ¹⁶ to acquire the identity and face shape consistency feature F_{ISC}, F_{ISC}∈R⁵¹²

Preferably, in the step e-3), the 1D convolutional layer of the temporal convolutional block includes a convolution kernel with a size of 1, a stride of 2, and a padding of 0; in the step e-4), the 1D convolutional layer of each of the first residual convolutional block, the second residual convolutional block, and the third residual convolutional block includes a convolution kernel with a size of 1, a stride of 2, and a padding of 0; in the step e-5), the multi-head attention mechanism of each of the first self-attention block, the second self-attention block, the third self-attention block, and the fourth self-attention block includes 6 heads; in the step e-7), the 1D convolutional layer of the identity feature mapping block includes a convolution kernel with a size of 3, a stride of 1, and a padding of 1; in the step e-8), the multi-head attention mechanism of each of the first CAB, the second CAB, the third CAB, and the fourth CAB includes 8 heads; in the step c-9), the dilated convolutional layer of each of the first dilated convolutional block and the second dilated convolutional block includes a convolution kernel with a size of 3, a stride of 1, a padding of 0, and a dilation factor of 2; the dilated convolutional layer of each of the third dilated convolutional block, the fourth dilated convolutional block, and the fifth dilated convolutional block includes a convolution kernel with a size of 3, a stride of 1, a padding of 0, and a dilation factor of 4; and the GroupNorm layer of each of the first dilated convolutional block, the second dilated convolutional block, the third dilated convolutional block, the fourth dilated convolutional block, and the fifth dilated convolutional block has a group size of 16.

Further, the step f) includes:
f-1) inputting the facial identity feature F_{id}ⁿ into the fusion unit of the identity feature consistency network; and calculating, by a torch.mean( ) function in PyTorch, a mean of the facial identity feature F_{id}ⁿ to acquire an identity feature F_{id}², F_{id}²∈R⁵¹²; and
f-2) concatenating, by a torch.concat( ) function in PyTorch, the identity feature F_{id}² with the identity and face shape consistency feature F_{ISC} to acquire the feature F_{IC}

Further, the step g) includes:
g-1) calculating the loss function L by L=ηL_{sid}+λL(ƒ_{emb}), where η and λ are scaling factors; L_{sid} denotes an embedding optimization loss of a fake identity; L(ƒ_{emb}) denotes a supervised contrastive learning loss;

$${L}_{sid} = \frac{1}{{N}_{F}} 1 \{ {y}_{i}^{s} = {y}_{j}^{s} \} {\sum }_{i ∈ {N}_{F}} δ ( {F}_{id}^{i} , {F}_{id}^{j} ) - \frac{1}{{N}_{R}} 1 \{ {y}_{i}^{s} = {y}_{j}^{s} \} {\sum }_{i ∈ {N}_{R}} δ ( {F}_{id}^{i} , {F}_{id}^{j} ) ;$$

$$1 \{ {y}_{i}^{s} = {y}_{j}^{s} \}$$

indicates that a value of 1 is taken when yᵢ^{s} equals yⱼ^{s} and a value of 0 is taken when yᵢ^{s} is not equal to yⱼ^{s}; yᵢ^{s} denotes the source identity label of the i-th image frame Xᵢ, i ∈{1, . . . ,L}; δ(·,·) denotes the cosine similarity calculation function; F_{id}ⁱ denotes a facial identity feature of an i-th video Vᵢ in the training set, i ∈{1, . . . ,N}; and F_{id}^{j} denotes a facial identity feature of a j-th video Vⱼ in the training set, j ∈{1, . . . , N}; and
g-2) training, by an adaptive moment estimation (Adam) optimizer, the identity feature consistency network through the loss function L to acquire the optimized identity feature consistency network.

Preferably, η is 0.2, and λ is 0.8.

Preferably, in the step h), τ∈(0,1).

The present disclosure has the following beneficial effects. The present disclosure combines an identity feature with a 3D face shape feature, and designs the FSCA and the IGSCA module to mine an identity and face shape inconsistency feature. The present disclosure achieves strong targeting performance based on reference face information for detecting different faces, and achieves strong generalized detection performance based on the identity and face shape information of the reference face, improving face detection performance and accuracy.

### BRIEF DESCRIPTION OF THE DRAWINGS

FIG. 1 is a flowchart of a Deepfake detection method based on identity and face shape features according to the present disclosure;

FIG. 2 is a structural diagram of a face shape consistency self-attention (FSCA) module according to the present disclosure; and

FIG. 3 is a structural diagram of an identity guided shape consistency attention (IGSCA) module according to the present disclosure.

### DETAILED DESCRIPTION OF THE EMBODIMENTS

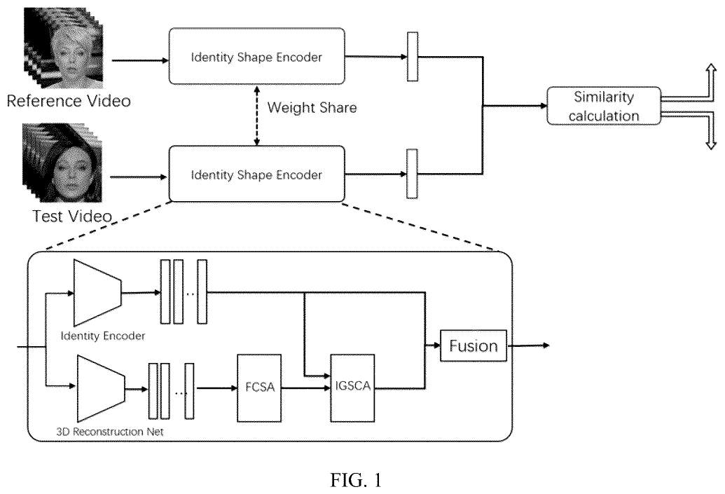

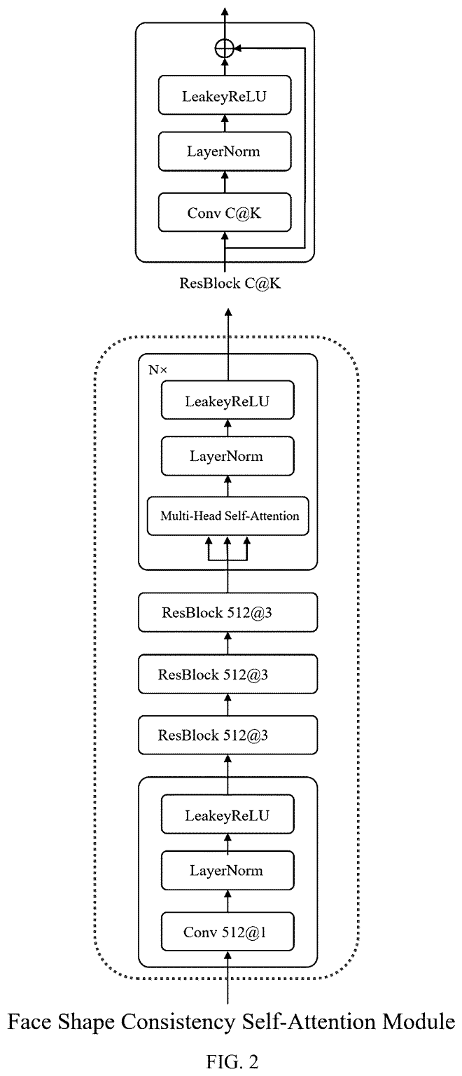

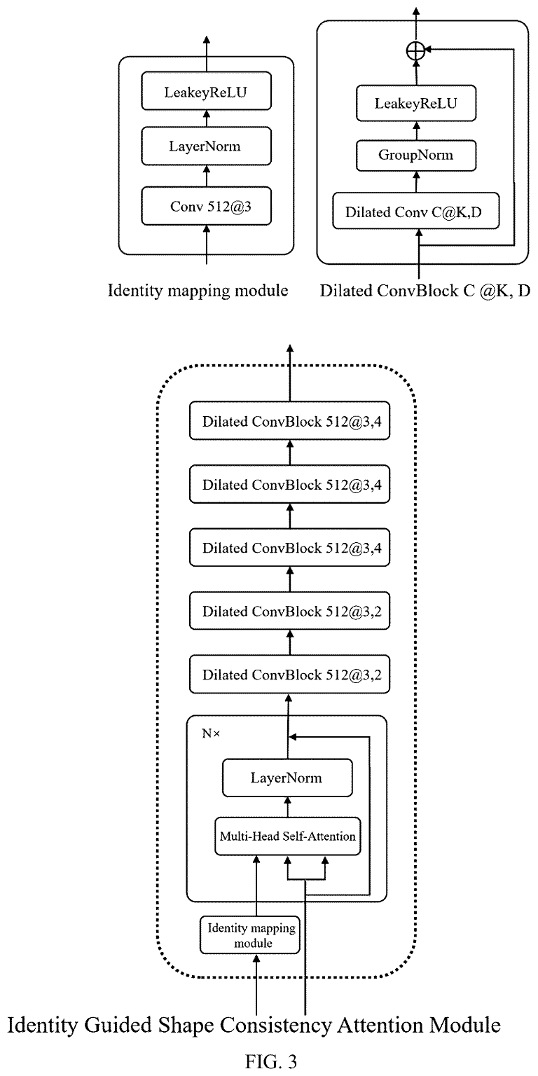

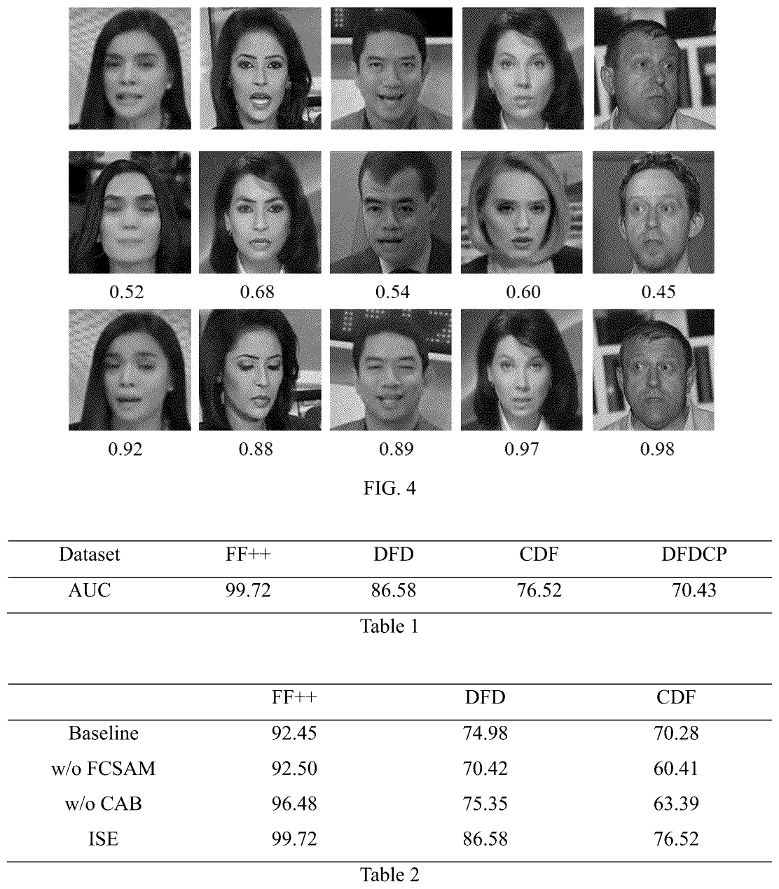

The present disclosure is further described below with reference to FIGS. 1, 2, and 3.

A Deepfake detection method based on identity and face shape features includes the following steps.

a) Videos are acquired to form a training set and a test set. Tensor Xₜᵣₐᵢₙ is extracted from the training set, and tensors Xₜₑₛₜ′ and X_{ref}′ are extracted from the test set.
b) The tensor Xₜᵣₐᵢₙ is input into an identity encoder to acquire facial identity feature F_{id}ⁿ.
c) An identity feature consistency network is constructed, including a three-dimensional (3D) reconstruction encoder, an identity and face shape consistency extraction network, and a fusion unit.
d) The tensor Xₜᵣₐᵢₙ is input into the 3D reconstruction encoder of the identity feature consistency network to acquire face shape feature Fₛₕₐₚₑ
e) The feature Fₛₕₐₚₑ and the facial identity feature F_{id}ⁿ are input into the identity and face shape consistency extraction network of the identity feature consistency network to acquire identity and face shape consistency feature F_{ISC}
f) The facial identity feature F_{id}ⁿ and the identity and face shape consistency feature F_{ISC} are input into the fusion unit of the identity feature consistency network for fusing to acquire feature F_{IC}.
g) Loss function L is calculated, and the identity feature consistency network is trained through the loss function L to acquire an optimized identity feature consistency network.
h) The tensor Xₜₑₛₜ′ is input into the optimized identity feature consistency network test to acquire feature F_{IC}′. X_{ref}′ is input into the optimized identity feature consistency network to acquire feature F_{IC}″. Similarity value S is calculated by s=δ(F_{IC}′,F_{IC}″) where δ(·,·) denotes a cosine similarity calculation function. It is determined that a face in a video is a real face if the similarity value S is greater than or equal to a threshold τ, and it is determined that the face in the video is a fake face if the similarity value S is less than τ. Specifically, τ∈(0,1).

The present disclosure provides a Deepfake detection method that combines a facial identity vector feature and a face shape feature, achieving strong targeting performance and good generalization performance for face detection.

In an embodiment of the present disclosure, the step a) is as follows.
a-1) N videos are acquired from a facial forgery dataset FaceForensics++ as the training set Vₜᵣₐᵢₙ and M videos are acquired as the test set Vₜₑₛₜ. Vₜᵣₐᵢₙ=V_{F}+V_{R}={V₁,V₂, . . . ,V. . . .,V_{N}}. The training set includes N_{F} fake videos and N_{R} real videos, N_{F}+N_{R}=N. V_{F} denotes a fake video set, and V_{R} denotes a real video set. Vₙ denotes an n-th video, n ∈{1, . . . , N}. The n-th video Vₙ includes L image frames, Vₙ={X₁,X₂, . . . , Xⱼ, . . . , X_{L}}. Xⱼ denotes a j-th image frame, j ∈{1, . . . , L}, and Xⱼ corresponds to class label y. . When the j-th image frame xⱼ is a real image, Xⱼ is 0. When the j-th image frame xⱼ is a fake image, Xⱼ is 1. The j-th image frame Xⱼ corresponds to source identity label yⱼ^{s}. Vₜₑₛₜ=V_{F}′+V_{R}′={V₁′,V₂′, . . . ,V_{M}′}. The test set includes M_{F} fake videos and M_{R} real videos, M_{F}+M_{R}=M. V_{F}′ denotes a fake video set, and V_{R}′denotes a real video set. Vₘ′ denotes an m-th video, m∈{1, . . . ,M}.
a-2) The n-th video Vₙ in the training set is read by VideoReader in opencv frame by frame. T consecutive video frames are randomly extracted from the n-th video Vₙ as training video Vₜᵣₐᵢₙ. A facial keypoint in each video frame of the training video Vₜᵣₐᵢₙ is detected by a multi-task cascaded convolutional network (MTCNN) algorithm, and a facial image is calibrated. A calibrated facial image is cut to form facial image matrix Xₜᵣₐᵢₙ′.
a-3) The m-th video Vₘ′ of the fake video set V_{F}′ in the test set frame is read by VideoReader in opencv by frame. T consecutive video frames are randomly extracted from the m-th video Vₘ′ as test video V_{test_1}. The m-th video Vₘ′ of the real video set V_{R}′ in the test set is read by VideoReader in opencv frame by frame. Two sets of T consecutive video frames are randomly extracted from the m-th video Vₘ′,where a first set of consecutive video frames forms test video V_{test_2}, and a second set of consecutive video frames forms reference video V_{ref}. Test video Vₜₑₛₜ is acquired by Vₜₑₛₜ=V_{test_1}+V_{test_2}. A facial keypoint in each video frame of the test video Vₜₑₛₜ is detected by the MTCNN algorithm, and a facial image is calibrated. A calibrated facial image is cut to form facial image matrix Xₜₑₛₜ′. A facial keypoint in each video frame of the reference video V_{ref} is detected by the MTCNN algorithm, and a facial image is calibrated. A calibrated facial image is cut to form facial image matrix X_{ref}′.
a-4) The facial image matrix Xₜᵣₐᵢₙ′ is transposed by a ToTensor( ) function in PyTorch into the tensor Xₜᵣₐᵢₙ, Xₜᵣₐᵢₙ∈R^{T×C×H×W}. The facial image matrix Xₜₑₛₜ′ is transposed into the tensor Xₜₑₛₜ, Xₜₑₛₜ∈R^{T×C×H×W}. The facial image matrix X_{ref}′ is transposed into the tensor X_{ref}, X_{ref} ∈R^{T×C×H×W}. R denotes a real number space, C denotes a channel number of the image frame, H denotes a height of the image frame, and W denotes a width of the image frame.

In an embodiment of the present disclosure, in the step b), the identity encoder is constructed, including an additive angular margin loss (ArcFace) face recognition model. The tensor Xₜᵣₐᵢₙ is input into the identity encoder to acquire identity feature F_{id}′ of the n-th video Vₙ in the training set, F_{id}′∈R^{T×512}, R being a real number space. The identity feature F_{id}ⁿ is transposed by a tensor.transpose( ) function in PyTorch into the facial identity feature F_{id}ⁿ of the n-th video Vₙ in the training set, F_{id}ⁿ∈R^{512×T}, n ∈{1, . . . , N}.

In an embodiment of the present disclosure, the step d) is as follows.
d-1) The 3D reconstruction encoder of the identity feature consistency network is constructed, including a pre-trained Deep3DFaceRecon network.
d-2) The tensor Xₜᵣₐᵢₙ is input into the 3D reconstruction encoder to acquire 3D morphable model (3DMM) identity feature Fₛₕₐₚₑ′.
d-3) The 3DMM identity feature F,hₐpe is transposed by the tensor.transpose( ) function in PyTorch into the face shape feature Fₛₕₐₚₑ, Fₛₕₐₚₑ∈R^{257×T}

In an embodiment of the present disclosure, the step e) is as follows.
e-1) The identity and face shape consistency extraction network of the identity feature consistency network is constructed, including a face shape consistency self-attention (FSCA) module and an identity guided shape consistency attention (IGSCA) module.
e-2) The FSCA module of the identity and face shape consistency extraction network is constructed, including a temporal convolutional block, a first residual convolutional block, a second residual convolutional block, a third residual convolutional block, a first self-attention block, a second self-attention block, a third self-attention block, and a fourth self-attention block.
e-3) The temporal convolutional block of the FSCA module is constructed, including a one-dimensional (1D) convolutional layer, a layer normalization (LayerNorm) layer, and a leaky rectified linear unit (LeakeyReLU) function. The face shape feature Fₛₕₐₚₑ is input is input into the 1D convolutional layer to acquire feature Fₛₕₐₚₑ¹⁻¹. The feature Fₛₕₐₚₑ¹⁻¹ is input into the LayerNorm layer to acquire feature Fₛₕₐₚₑ¹⁻². The feature Fₛₕₐₚₑ¹⁻² is input into the LeakeyReLU function to acquire feature Fₛₕₐₚₑ¹, Fₛₕₐₚₑ¹ ∈R^{512×T}.
e-4) The first residual convolutional block, the second residual convolutional block, and the third residual convolutional block of the FSCA module are constructed, each including a ID convolutional layer, a LayerNorm layer, and a LeakeyReLU function. The feature Fₛₕₐₚₑ¹ is input into the 1D convolutional layer of the first residual convolutional block to acquire feature Fₛₕₐₚₑ²⁻¹, the feature Fₛₕₐₚₑ²⁻¹ is input into the LayerNorm layer of the first residual convolutional block to acquire feature Fₛₕₐₚₑ²⁻², the feature Fₛₕₐₚₑ²⁻² is input into the LeakeyReLU function of the first residual convolutional block to acquire feature Fₛₕₐₚₑ²⁻³, and the feature Fₛₕₐₚₑ¹ is added to the feature Fₛₕₐₚₑ²⁻³ to acquire feature Fₛₕₐₚₑ². The feature Fₛₕₐₚₑ² is input into the 1D convolutional layer of the second residual convolutional block to acquire feature Fₛₕₐₚₑ³⁻¹, the feature Fₛₕₐₚₑ³⁻¹ is input into the LayerNorm layer of the second residual convolutional block to acquire feature Fₛₕₐₚₑ³⁻², the feature Fₛₕₐₚₑ³⁻² is input into the LeakeyReLU function of the second residual convolutional block to acquire feature Fₛₕₐₚₑ³⁻³, and the feature Fₛₕₐₚₑ² is added to the feature Fₛₕₐₚₑ³⁻³ to acquire feature Fₛₕₐₚₑ³. The feature Fₛₕₐₚₑ³ is input into the 1D convolutional layer of the third residual convolutional block to acquire feature Fₛₕₐₚₑ⁴⁻¹, the feature Fₛₕₐₚₑ⁴⁻¹ is input into the LayerNorm layer of the third residual convolutional block to acquire feature Fₛₕₐₚₑ⁴⁻², the feature Fₛₕₐₚₑ⁴⁻² is input into the LeakeyReLU function of the third residual convolutional block to acquire feature Fₛₕₐₚₑ⁴⁻³, and the feature Fₛₕₐₚₑ³ is added to the feature Fₛₕₐₚₑ⁴⁻³ to acquire feature Fₛₕₐₚₑ⁴.
e-5) The first self-attention block, the second self-attention block, the third self-attention block, and the fourth self-attention block of the FSCA module are constructed, each including a multi-head attention mechanism and a LayerNorm layer. The feature Fₛₕₐₚₑ⁴ is transposed by the tensor.transpose( ) function in PyTorch into feature Fₛₕₐₚₑ⁴′, Fₛₕₐₚₑ⁴′∈R^{T×512}. The feature Fₛₕₐₚₑ⁴′ is input into the multi-head attention mechanism of the first self-attention block to acquire feature Fₛₕₐₚₑ⁵⁻¹, the feature Fₛₕₐₚₑ⁵⁻¹ is input into the LayerNorm layer of the first self-attention block to acquire feature Fₛₕₐₚₑ⁵⁻¹′, and the feature Fₛₕₐₚₑ⁵⁻¹′ is added to the feature Fₛₕₐₚₑ⁴′ to acquire feature Fₛₕₐₚₑ⁵. The feature Fₛₕₐₚₑ⁵ is input into the multi-head attention mechanism of the second self-attention block to acquire feature Fₛₕₐₚₑ⁶⁻¹, the feature Fₛₕₐₚₑ⁶⁻¹ is input into the LayerNorm layer of the second self-attention block to acquire feature Fₛₕₐₚₑ⁶⁻¹′, and the feature Fₛₕₐₚₑ⁶⁻¹′ is added to the feature Fₛₕₐₚₑ⁵ to acquire feature Fₛₕₐₚₑ⁶. The feature Fₛₕₐₚₑ⁶ is input into the multi-head attention mechanism of the third self-attention block to acquire feature Fₛₕₐₚₑ⁷⁻¹, the feature Fₛₕₐₚₑ⁷⁻¹ is input into the LayerNorm layer of the third self-attention block to acquire feature Fₛₕₐₚₑ⁷⁻¹′, and the feature Fₛₕₐₚₑ⁷⁻¹′ is added to the feature Fₛₕₐₚₑ⁶ to acquire feature Fₛₕₐₚₑ⁷. The feature Fₛₕₐₚₑ⁷ is input into the multi-head attention mechanism of the fourth self-attention block to acquire feature Fₛₕₐₚₑ⁸⁻¹, the feature Fₛₕₐₚₑ⁸⁻¹ is input into the LayerNorm layer of the fourth self-attention block to acquire feature Fₛₕₐₚₑ⁸⁻¹′, and the feature Fₛₕₐₚₑ⁸⁻¹′ is added to the feature Fₛₕₐₚₑ⁷ to acquire feature Fₛₕₐₚₑ⁸, Fₛₕₐₚₑ⁸ ∈R^{T×512}
e-6) The IGSCA module of the identity feature consistency network is constructed, including an identity feature mapping block, a first cross attention block (CAB), a second CAB, a third CAB, a fourth CAB, a first dilated convolutional block, a second dilated convolutional block, a third dilated convolutional block, a fourth dilated convolutional block, and a fifth dilated convolutional block.
e-7) The identity feature mapping block of the IGSCA module is constructed, including a 1D convolutional layer, a LayerNorm layer, and a LeakeyReLU function. The facial identity feature F_{id}ⁿ is input into the 1D convolutional layer of the identity feature mapping block to acquire feature F_{id}¹⁻¹. The feature F_{id}¹⁻¹ is input into the LayerNorm layer of the identity feature mapping block to acquire feature F_{id}¹⁻². The feature F_{id}¹⁻² is input into the LeakeyReLU function of the identity feature mapping block to acquire feature F_{id}¹⁻³. The feature F_{id}¹⁻³ is transposed by the tensor.transpose( ) function in PyTorch into feature F_{id}1, F_{id}¹∈R^{T×512}.
e-8) The first CAB, the second CAB, the third CAB, and the fourth CAB of the IGSCA module are constructed, each including a multi-head attention mechanism, a LayerNorm layer, and a LeakeyReLU function. A linear transformation is performed on the feature F_{id}¹ to acquire a value of query in the multi-head attention mechanism of the first CAB. A linear transformation is performed on the feature Fₛₕₐₚₑ⁸ to acquire values of key and value in the multi-head attention mechanism of the first CAB, thereby acquiring output feature Fₛₕₐₚₑ⁹⁻¹ of the multi-head attention mechanism in the first CAB. The feature Fₛₕₐₚₑ⁹⁻¹ is input into the LayerNorm layer of the first CAB to acquire feature Fₛₕₐₚₑ⁹⁻¹′. The feature Fₛₕₐₚₑ⁹⁻¹′ is added to the feature Fₛₕₐₚₑ⁸ to acquire feature Fₛₕₐₚₑ⁹. A linear transformation is performed on the feature F_{id}¹ to acquire a value of query in the multi-head attention mechanism of the second CAB. A linear transformation is performed on the feature Fₛₕₐₚₑ⁹ to acquire values of key and value in the multi-head attention mechanism of the second CAB, thereby acquiring output feature Fₛₕₐₚₑ¹⁰⁻¹ of the multi-head attention mechanism in the second CAB. The feature Fₛₕₐₚₑ¹⁰⁻¹ is input into the LayerNorm layer of the second CAB to acquire feature Fₛₕₐₚₑ¹⁰⁻¹′. The feature Fₛₕₐₚₑ¹⁰⁻¹′ is added to the feature Fₛₕₐₚₑ⁹ to acquire feature Fₛₕₐₚₑ¹⁰. A linear transformation is performed on the feature F_{id}¹ to acquire a value of query in the multi-head attention mechanism of the third CAB. A linear transformation is performed on the feature Fₛₕₐₚₑ¹⁰ to acquire values of key and value in the multi-head attention mechanism of the third CAB, thereby acquiring output feature Fₛₕₐₚₑ¹¹⁻¹ of the multi-head attention mechanism in the third CAB. The feature Fₛₕₐₚₑ¹¹⁻¹ is input into the LayerNorm layer of the third CAB to acquire feature Fₛₕₐₚₑ¹¹⁻¹′. The feature Fₛₕₐₚₑ¹¹⁻¹′ is added to the feature Fₛₕₐₚₑ¹⁰, to acquire feature Fₛₕₐₚₑ¹¹. A linear transformation is performed on the feature F_{id}¹ to acquire a value of query in the multi-head attention mechanism of the fourth CAB. A linear transformation is performed on the feature Fₛₕₐₚₑ¹¹ to acquire values of key and value in the multi-head attention mechanism of the fourth CAB, thereby acquiring an output feature Fₛₕₐₚₑ¹²⁻¹ of the multi-head attention mechanism in the fourth CAB. The feature Fₛₕₐₚₑ¹²⁻¹ is input into the LayerNorm layer of the fourth CAB to acquire feature Fₛₕₐₚₑ¹²⁻¹′. The feature Fₛₕₐₚₑ¹²⁻¹′ is added to the feature Fₛₕₐₚₑ¹¹ to acquire feature Fₛₕₐₚₑ¹².
e-9) The first dilated convolutional block, the second dilated convolutional block, the third dilated convolutional block, the fourth dilated convolutional block, and the fifth dilated convolutional block of the IGSCA module are constructed, each including a dilated convolutional layer, a group normalization (GroupNorm) layer, and a LeakeyReLU function. The feature Fₛₕₐₚₑ¹², is input into the dilated convolutional layer of the first dilated convolutional block to acquire feature Fₛₕₐₚₑ¹³⁻¹, the feature Fₛₕₐₚₑ¹³⁻¹ is input into the GroupNorm layer of the first dilated convolutional block to acquire feature Fₛₕₐₚₑ¹³⁻², the feature Fₛₕₐₚₑ¹³⁻² is input into the LeakeyReLU function of the first dilated convolutional block to acquire feature Fₛₕₐₚₑ¹³⁻²′, and the feature Fₛₕₐₚₑ¹³⁻² is added to the feature Fₛₕₐₚₑ¹² to acquire feature Fₛₕₐₚₑ¹³. The feature Fₛₕₐₚₑ¹³ is input into the dilated convolutional layer of the second dilated convolutional block to acquire feature Fₛₕₐₚₑ¹⁴⁻¹, the feature Fₛₕₐₚₑ¹⁴⁻¹ is input into the GroupNorm layer of the second dilated convolutional block to acquire feature Fₛₕₐₚₑ¹⁴⁻², the feature Fₛₕₐₚₑ¹⁴⁻² is input into the LeakeyReLU function of the second dilated convolutional block to acquire feature Fₛₕₐₚₑ¹⁴⁻²′, and the feature Fₛₕₐₚₑ¹⁴⁻²′ is added to the feature Fₛₕₐₚₑ¹³ to acquire feature Fₛₕₐₚₑ¹⁴. The feature Fₛₕₐₚₑ¹⁴ is input into the dilated convolutional layer of the third dilated convolutional block to acquire feature Fₛₕₐₚₑ¹⁵⁻¹, the feature Fₛₕₐₚₑ¹⁵⁻¹ is input into the GroupNorm layer of the third dilated convolutional block to acquire feature Fₛₕₐₚₑ¹⁵⁻², thethe feature Fₛₕₐₚₑ¹⁵⁻² is input into the LeakeyReLU function of the third dilated convolutional block to acquire feature Fₛₕₐₚₑ¹⁵⁻²′, and the feature Fₛₕₐₚₑ¹⁵⁻²′ is added to the feature Fₛₕₐₚₑ¹⁴ to acquire feature Fₛₕₐₚₑ¹⁵. The feature Fₛₕₐₚₑ¹⁵ is input into the dilated convolutional layer of the fourth dilated convolutional block to acquire feature Fₛₕₐₚₑ¹⁶⁻¹, the feature Fₛₕₐₚₑ¹⁶⁻¹ is input into the GroupNorm layer of the fourth dilated convolutional block to acquire feature Fₛₕₐₚₑ¹⁶⁻², the feature Fₛₕₐₚₑ¹⁶⁻² is input into the LeakeyReLU function of the fourth dilated convolutional block to acquire feature Fₛₕₐₚₑ¹⁶⁻²′, and the feature Fₛₕₐₚₑ¹⁶⁻²′ is added to the feature Fₛₕₐₚₑ¹⁵ to acquire feature Fₛₕₐₚₑ¹⁶. The feature Fₛₕₐₚₑ¹⁶ is input into the dilated convolutional layer of the fifth dilated convolutional block to acquire feature Fₛₕₐₚₑ¹⁷⁻¹,the feature Fₛₕₐₚₑ¹⁷⁻¹ is input into the GroupNorm layer of the fifth dilated convolutional block to acquire feature Fₛₕₐₚₑ¹⁷⁻² the feature Fₛₕₐₚₑ¹⁷⁻² is input into the LeakeyReLU function of the fifth dilated convolutional block to acquire feature Fₛₕₐₚₑ¹⁷⁻²′, and the feature Fₛₕₐₚₑ¹⁷⁻²′ is added to the feature Fₛₕₐₚₑ¹⁶ to acquire the identity and face shape consistency feature F_{ISC}, F_{ISC}∈R⁵¹²

In this embodiment, in the step e-3), the 1D convolutional layer of the temporal convolutional block includes a convolution kernel with a size of 1, a stride of 2, and a padding of 0. In the step e-4), the 1D convolutional layer of each of the first residual convolutional block, the second residual convolutional block, and the third residual convolutional block includes a convolution kernel with a size of 1, a stride of 2, and a padding of 0. In the step e-5), the multi-head attention mechanism of each of the first self-attention block, the second self-attention block, the third self-attention block, and the fourth self-attention block includes 6 heads. In the step e-7), the 1D convolutional layer of the identity feature mapping block includes a convolution kernel with a size of 3, a stride of 1, and a padding of 1. In the step e-8), the multi-head attention mechanism of each of the first CAB, the second CAB, the third CAB, and the fourth CAB includes 8 heads. In the step c-9), the dilated convolutional layer of each of the first dilated convolutional block and the second dilated convolutional block includes a convolution kernel with a size of 3, a stride of 1, a padding of 0, and a dilation factor of 2. The dilated convolutional layer of each of the third dilated convolutional block, the fourth dilated convolutional block, and the fifth dilated convolutional block includes a convolution kernel with a size of 3, a stride of 1, a padding of 0, and a dilation factor of 4. The GroupNorm layer of each of the first dilated convolutional block, the second dilated convolutional block, the third dilated convolutional block, the fourth dilated convolutional block, and the fifth dilated convolutional block has a group size of 16.

In an embodiment of the present disclosure, the step f) is as follows.
f-1) The facial identity feature F_{id}ⁿ is input into the fusion unit of the identity feature consistency network. A mean of the facial identity feature F_{id}ⁿ is calculated by a torch.mean( ) function in PyTorch to acquire identity feature F_{id}²,F_{id}²∈R⁵¹².
f-2) The identity feature F_{id}² is concatenated with the identity and face shape consistency feature F_{ISC} by a torch.concat( ) function in PyTorch to acquire the feature F_{IC}.

In an embodiment of the present disclosure, the step g) is as follows.
g-1) The loss function L is calculated by L=ηL_{sid}+λL(ƒ_{emb}). η and λ are scaling factors. L_{sid} denotes an embedding optimization loss of a fake identity. L (ƒ_{emb}) denotes a supervised contrastive learning loss. This loss is a prior art. For details, please refer to Kim J, Lee J, Zhang B T. Smooth-swap: a simple enhancement for face-swapping with smoothness[C]//Proceedings of the IEEE/CVF Conference on Computer Vision and Pattern Recognition. 2022: 10779-10788.

$${L}_{sid} = \frac{1}{{N}_{F}} 1 \{ {y}_{i}^{s} = {y}_{j}^{s} \} {\sum }_{i ∈ {N}_{F}} δ ( {F}_{id}^{i} , {F}_{id}^{j} ) - \frac{1}{{N}_{R}} 1 \{ {y}_{i}^{s} = {y}_{j}^{s} \} {\sum }_{i ∈ {N}_{R}} δ ( {F}_{id}^{i} , {F}_{id}^{j} ) .$$

$$1 \{ {y}_{i}^{s} = {y}_{j}^{s} \}$$

indicates that a value of 1 is taken when yᵢ^{s} equals yⱼ^{s} and a value of 0 is taken when yᵢ^{s} is not equal to yⱼ^{s}. yᵢ^{s} denotes the source identity label of the i-th image frame Xᵢ, i ∈{1, . . . ,L}. δ(·,·) denotes the cosine similarity calculation function. F_{id}ⁱ denotes a facial identity feature of i-th video Vᵢ in the training set, i ∈{1, . . . , N}. F_{id}^{j} denotes a facial identity feature of j-th video Vᵢ in the training set, j ∈{1, . . . , N}.
g-2) The identity feature consistency network is trained by an adaptive moment estimation (Adam) optimizer through the loss function L to acquire the optimized identity feature consistency network.

Finally, it should be noted that the above descriptions are only preferred embodiments of the present disclosure, and are not intended to limit the present disclosure. Although the present disclosure has been described in detail with reference to the foregoing embodiments, those skilled in the art may still modify the technical solutions described in the foregoing embodiments, or equivalently substitute some technical features thereof. Any modification, equivalent substitution, improvement, etc. within the spirit and principles of the present disclosure shall fall within the scope of protection of the present disclosure.

### Experimental Results

Experiments were conducted on multiple datasets, including FaceForensics++(FF++), Deepfake Detection (DFD), Celeb DF (CDF), and Deepfake detection challenge preview (DFDCP). In the present disclosure, a FF++dataset was taken as the training set, and Area Under Curve (AUC) was taken as an evaluation indicator for faking. As shown in Table 1, on the intra-domain dataset FF++, the AUC detected by Deepfake was 99.72%, while on cross-domain datasets such as DFD, CDF, and DFDCP, the AUC detected by Deepfake reached 86.58%, 76.52%, and 70.43%, respectively.

FIG. 4 shows the similarity between some test videos and the reference video on the FF++ test set. The first row demonstrates reference videos, the second row demonstrates test fake videos and their corresponding similarity, and the third row demonstrates test real videos and their corresponding similarity. The fake video has a low similarity with the reference video, while the real video has a high similarity with the reference video.

To demonstrate the effectiveness of the various modules proposed in the present disclosure, experiments were conducted on multiple datasets, as shown in Table 2. The combination of Arcface and RNN was taken the baseline for comparison, where w/o denotes without, i.e. missing a certain component, FSCA denotes the face shape consistency self-attention module, CAB denotes the cross attention block in the IGSCA module, and ISE denotes the identity shape encoder, which is the entire model of the present disclosure. Compared to the baseline, the performance of the method of the present disclosure is improved by about 7% to 12%, demonstrating the effectiveness of introducing 3D face shapes. The face shape consistency attention model proposed in the present disclosure uses a self-attention mechanism to guide the model to learn the consistency of face shapes in videos. When this module is not used, the performance decreases by about 7% to 16%, proving the effectiveness of the face shape consistency attention module. The CAB proposed in the present disclosure guides the model to learn the relationship between the 3D face shape and the identity feature, and the performance decreases by about 3% to 13% when this module is not used, proving the effectiveness of the module.

1. A Deepfake detection method based on identity and face shape features, comprising the following steps:
a) acquiring videos to form a training set and a test set, extracting a tensor Xₜᵣₐᵢₙ from the training set, and extracting tensors Xₜₑₛₜ′ and X_{ref}′ from the test set;
b) inputting the tensor Xₜᵣₐᵢₙ into an identity encoder to acquire a facial identity feature F_{id}ⁿ;
c) constructing an identity feature consistency network, comprising a three-dimensional (3D) reconstruction encoder, an identity and face shape consistency extraction network, and a fusion unit;
d) inputting the tensor Xₜᵣₐᵢₙ into the 3D reconstruction encoder of the identity feature consistency network to acquire a face shape feature Fₛₕₐₚₑ;
e) inputting the face shape feature Fₛₕₐₚₑ and the facial identity feature F_{id}ⁿ into the identity and face shape consistency extraction network of the identity feature consistency network to acquire an identity and face shape consistency feature F_{ISC}
f) inputting the facial identity feature F_{id}ⁿ and the identity and face shape consistency feature F_{ISC} into the fusion unit of the identity feature consistency network for fusing to acquire a feature F_{IC};
g) calculating a loss function L, and training the identity feature consistency network through the loss function L to acquire an optimized identity feature consistency network; and
h) inputting the tensor Xₜₑₛₜ′ into the optimized identity feature consistency network to acquire a feature F_{IC}′; inputting X_{ref}′ into the optimized identity feature consistency network to acquire a feature F_{IC}″; and calculating a similarity value S by s=δ(F_{IC}′, F_{IC}″), wherein δ(·,·) denotes a cosine similarity calculation function; determining that a face in a video is a real face if the similarity value S is greater than or equal to a threshold τ; and determining that the face in the video is a fake face if the similarity value S is less than τ.

2. The Deepfake detection method based on the identity and the face shape features according to claim 1, wherein the step a) comprises:
a-1) acquiring, from a facial forgery dataset FaceForensics++, N videos as the training set Vₜᵣₐᵢₙ and M videos as the test set Vₜₑₛₜ, wherein Vₜᵣₐᵢₙ=V_{F}+V_{R}={V₁,V₂, . . . ,Vₙ, . . . ,V_{N}}; the training set comprises N_{F} fake videos and N_{R} real videos, N_{F}+N_{R}=N; V_{F} denotes a fake video set, and V_{R} denotes a real video set; Vₙ denotes an n-th video, n ∈{1, . . . , N}; the n-th video Vₙ comprises L image frames, Vₙ={x₁, X₂, . . . , Xⱼ, . . . , X_{L}}; Xⱼ denotes a j-th image frame, j ∈{1, . . . ,L}, and X. corresponds to a class label y. ; when the j-th image frame xⱼ is a real image, Xⱼ is 0; when the j-th image frame xⱼ is a fake image, Xⱼ is 1; the j-th image frame Xⱼ corresponds to a source identity label yⱼ^{s}; Vₜₑₛₜ=V_{F}′+V_{R}′={V₁′,V₂′, . . . ,Vₘ′, . . . ,V_{M}′ } the test set comprises M_{F} fake videos and M_{R} real videos, M_{F}+M_{R}=M; V_{F}′ denotes a fake video set, and V_{R}′ denotes a real video set; and Vₘ′ denotes an m-th video, m ∈{1, . . . ,M};
a-2) reading, by VideoReader in opencv, the n-th video Vₙ in the training set frame by frame; randomly extracting T consecutive video frames from the n-th video Vₙ as a training video Vₜᵣₐᵢₙ; detecting, by a multi-task cascaded convolutional network (MTCNN) algorithm, a facial keypoint in each video frame of the training video Vₜᵣₐᵢₙ, and calibrating a facial image; and cutting a calibrated facial image to form a facial image matrix Xₜᵣₐᵢₙ′;
a-3) reading, by VideoReader in opencv, the m-th video Vₘ′ of the fake video set V_{F}′ in the test set frame by frame; and randomly extracting T consecutive video frames from the m-th video Vₘ′ as a test video V_{test_1}; reading, by VideoReader in opencv, the m-th video Vₘ′ of the real video set V_{R}′ in the test set frame by frame; randomly extracting two sets of T consecutive video frames from the m-th video Vₘ′, wherein a first set of consecutive video frames forms a test video V_{test_2}, and a second set of consecutive video frames forms a reference video V_{ref}; acquiring a test video Vₜₑₛₜ by Vₜₑₛₜ=V_{test_1}+V_{test_2}; detecting, by the MTCNN algorithm, a facial keypoint in each video frame of the test video Vₜₑₛₜ, and calibrating a facial image; cutting a calibrated facial image to form a facial image matrix Xₜₑₛₜ′; detecting, by the MTCNN algorithm, a facial keypoint in each video frame of the reference video V_{ref}, and calibrating a facial image; and cutting a calibrated facial image to form a facial image matrix X_{ref}′; and
a-4) transposing, by a ToTensor( ) function in PyTorch, the facial image matrix Xₜᵣₐᵢₙ′ into the tensor Xₜᵣₐᵢₙ Xₜᵣₐᵢₙ ∈R^{T×C×H×W}, transposing the facial image matrix Xₜₑₛₜ′, into a tensor Xₜₑₛₜ, Xₜₑₛₜ∈R^{T×C×H×W}, and transposing the facial image matrix X_{ref}′ into a tensor X_{ref}, X_{ref} ∈R^{T×C×H×W}, wherein R denotes a real number space, C denotes a channel number of the image frame, H denotes a height of the image frame, and W denotes a width of the image frame.

3. The Deepfake detection method based on the identity and the face shape features according to claim 2, wherein the step b) comprises: constructing the identity encoder, comprising an additive angular margin loss (ArcFace) face recognition model; inputting the tensor Xₜᵣₐᵢₙ into the identity encoder to acquire an identity feature F_{id}′ of the n-th video Vₙ in the training set, F_{id}′ ∈R^{T×512}; and transposing by a function in PyTorch, the identity feature F_{id}′ into the facial identity feature F_{id}ⁿ of the n-th video Vₙ in the training set, F_{id}ⁿ ∈R^{512×T}, n ∈{1, . . . , N}.

4. The Deepfake detection method based on the identity and the face shape features according to claim 3, wherein the step d) comprises:
d-1) constructing the 3D reconstruction encoder of the identity feature consistency network, comprising a pre-trained Deep3DFaceRecon network;
d-2) inputting the tensor Xₜᵣₐᵢₙ into the 3D reconstruction encoder to acquire a 3D morphable model (3DMM) identity feature Fₛₕₐₚₑ′;
d-3) transposing, by the tensor.transpose( ) function in PyTorch, the 3DMM identity feature Fₛₕₐₚₑ′ into the face shape feature Fₛₕₐₚₑ,Fₛₕₐₚₑ∈R^{257×T}.

5. The Deepfake detection method based on the identity and the face shape features according to claim 3, wherein the step e) comprises:
e-1) constructing the identity and face shape consistency extraction network of the identity feature consistency network, comprising a face shape consistency self-attention (FSCA) module and an identity guided shape consistency attention (IGSCA) module;
e-2) constructing the FSCA module of the identity and face shape consistency extraction network, comprising a temporal convolutional block, a first residual convolutional block, a second residual convolutional block, a third residual convolutional block, a first self-attention block, a second self-attention block, a third self-attention block, and a fourth self-attention block;
e-3) constructing the temporal convolutional block of the FSCA module, comprising a one-dimensional (1D) convolutional layer, a layer normalization (LayerNorm) layer, and a leaky rectified linear unit (LeakeyReLU) function; inputting the face shape feature Fₛₕₐₚₑ into the 1D convolutional layer to acquire a feature Fₛₕₐₚₑ¹⁻¹; inputting the feature Fₛₕₐₚₑ¹⁻¹ into the LayerNorm layer to acquire a feature Fₛₕₐₚₑ¹⁻²; and inputting the feature Fₛₕₐₚₑ¹⁻² into the LeakeyReLU function to acquire a feature Fₛₕₐₚₑ¹,Fₛₕₐₚₑ¹ ∈R^{512×T}
e-4) constructing the first residual convolutional block, the second residual convolutional block, and the third residual convolutional block of the FSCA module, each comprising a 1D convolutional layer, a LayerNorm layer, and a LeakeyReLU function; inputting the feature Fₛₕₐₚₑ¹ into the 1D convolutional layer of the first residual convolutional block to acquire a feature Fₛₕₐₚₑ²⁻¹, inputting the feature Fₛₕₐₚₑ²⁻¹ into the LayerNorm layer of the first residual convolutional block to acquire a feature Fₛₕₐₚₑ²⁻², inputting the feature Fₛₕₐₚₑ²⁻² into the LeakeyReLU function of the first residual convolutional block to acquire a feature Fₛₕₐₚₑ²⁻³ and adding the feature Fₛₕₐₚₑ¹ to the feature Fₛₕₐₚₑ²⁻³, to acquire a feature Fₛₕₐₚₑ²; inputting the feature Fₛₕₐₚₑ² into the 1D convolutional layer of the second residual convolutional block to acquire a feature Fₛₕₐₚₑ³⁻¹, inputting the feature Fₛₕₐₚₑ³⁻¹ into the LayerNorm layer of the second residual convolutional block to acquire a feature Fₛₕₐₚₑ³⁻² inputting the feature Fₛₕₐₚₑ³⁻² into the LeakeyReLU function of the second residual convolutional block to acquire a feature Fₛₕₐₚₑ³⁻³, and adding the feature Fₛₕₐₚₑ² to the feature Fₛₕₐₚₑ³⁻³ to acquire a feature Fₛₕₐₚₑ³, ; and inputting the feature Fₛₕₐₚₑ³ into the 1D convolutional layer of the third residual convolutional block to acquire a feature Fₛₕₐₚₑ⁴⁻¹, inputting the feature Fₛₕₐₚₑ⁴⁻¹ into the LayerNorm layer of the third residual convolutional block to acquire a feature Fₛₕₐₚₑ⁴⁻², inputting the feature Fₛₕₐₚₑ⁴⁻² into the LeakeyReLU function of the third residual convolutional block to acquire a feature Fₛₕₐₚₑ⁴⁻³, and adding the feature Fₛₕₐₚₑ³ to the feature Fₛₕₐₚₑ⁴⁻³ to acquire a feature Fₛₕₐₚₑ⁴;
e-5) constructing the first self-attention block, the second self-attention block, the third self-attention block, and the fourth self-attention block of the FSCA module, each comprising a multi-head attention mechanism and a LayerNorm layer; transposing, by the tensor.transpose( ) function in PyTorch, the feature Fₛₕₐₚₑ⁴ into a feature Fₛₕₐₚₑ⁴′, Fₛₕₐₚₑ⁴′∈R^{T×512}; inputting the feature Fₛₕₐₚₑ⁴′ into the multi-head attention mechanism of the first self-attention block to acquire a feature Fₛₕₐₚₑ⁵⁻¹, inputting the feature Fₛₕₐₚₑ⁵⁻¹ into the LayerNorm layer of the first self-attention block to acquire a feature Fₛₕₐₚₑ⁵⁻¹′, and adding the feature Fₛₕₐₚₑ⁵⁻¹′ to the feature Fₛₕₐₚₑ⁴′ to acquire a feature Fₛₕₐₚₑ⁵; inputting the feature Fₛₕₐₚₑ⁵ into the multi-head attention mechanism of the second self-attention block to acquire a feature Fₛₕₐₚₑ⁶⁻¹, inputting the feature Fₛₕₐₚₑ⁶⁻¹ into the LayerNorm layer of the second self-attention block to acquire a feature Fₛₕₐₚₑ⁶⁻¹′, and adding the feature Fₛₕₐₚₑ⁶⁻¹′ to the feature Fₛₕₐₚₑ⁵ to acquire a feature Fₛₕₐₚₑ⁶; inputting the feature Fₛₕₐₚₑ⁶ into the multi-head attention mechanism of the third self-attention block to acquire a feature Fₛₕₐₚₑ⁷⁻¹, inputting the feature Fₛₕₐₚₑ⁷⁻¹ into the LayerNorm layer of the third self-attention block to acquire a feature Fₛₕₐₚₑ⁷⁻¹′, and adding the feature Fₛₕₐₚₑ⁷⁻¹′ to the feature Fₛₕₐₚₑ⁶ to acquire a feature Fₛₕₐₚₑ⁷; and inputting the feature Fₛₕₐₚₑ⁷ into the multi-head attention mechanism of the fourth self-attention block to acquire a feature Fₛₕₐₚₑ⁸⁻¹, inputting the feature Fₛₕₐₚₑ⁸⁻¹ into the LayerNorm layer of the fourth self-attention block to acquire a feature Fₛₕₐₚₑ⁸⁻¹′, and adding the feature Fₛₕₐₚₑ⁸⁻¹′ to the feature Fₛₕₐₚₑ⁷ to acquire a feature FFₛₕₐₚₑ⁸, Fₛₕₐₚₑ⁸∈R^{T×512}
e-6) constructing the IGSCA module of the identity feature consistency network, comprising an identity feature mapping block, a first cross attention block (CAB), a second CAB, a third CAB, a fourth CAB, a first dilated convolutional block, a second dilated convolutional block, a third dilated convolutional block, a fourth dilated convolutional block, and a fifth dilated convolutional block;
e-7) constructing the identity feature mapping block of the IGSCA module, comprising a ID convolutional layer, a LayerNorm layer, and a LeakeyReLU function; inputting the facial identity feature F_{id}ⁿ into the 1D convolutional layer of the identity feature mapping block to acquire a feature F_{id}¹⁻¹; inputting the feature F_{id}¹⁻¹ into the LayerNorm layer of the identity feature mapping block to acquire a feature F_{id}¹⁻²; inputting the feature F_{id}¹⁻² into the LeakeyReLU function of the identity feature mapping block to acquire a feature F_{id}¹⁻³; and transposing, by the tensor.transpose( ) function in PyTorch, the feature F_{id}¹⁻³ into a feature F_{id}¹,F_{id}¹∈R_{T×512};
e-8) constructing the first CAB, the second CAB, the third CAB, and the fourth CAB of the IGSCA module, each comprising a multi-head attention mechanism, a LayerNorm layer, and a LeakeyReLU function; performing a linear transformation on the feature F_{id}¹ to acquire a value of query in the multi-head attention mechanism of the first CAB; performing a linear transformation on the feature Fₛₕₐₚₑ⁸ to acquire values of key and value in the multi-head attention mechanism of the first CAB, wherein an output feature Fₛₕₐₚₑ⁹⁻¹ of the multi-head attention mechanism in the first CAB is acquired; inputting the feature Fₛₕₐₚₑ⁹⁻¹ into the LayerNorm layer of the first CAB to acquire a feature Fₛₕₐₚₑ⁹⁻¹′; adding the feature Fₛₕₐₚₑ⁹⁻¹′ to the feature Fₛₕₐₚₑ⁷ to acquire a feature Fₛₕₐₚₑ⁹; performing a linear transformation on the feature F_{id}¹ to acquire a value of query in the multi-head attention mechanism of the second CAB; performing a linear transformation on the feature Fₛₕₐₚₑ⁹ to acquire values of key and value in the multi-head attention mechanism of the second CAB, wherein an output feature Fₛₕₐₚₑ¹⁰⁻¹ of the multi-head attention mechanism in the second CAB is acquired; inputting the feature Fₛₕₐₚₑ¹⁰⁻¹ into the LayerNorm layer of the second CAB to acquire a feature Fₛₕₐₚₑ¹⁰⁻¹′; adding the feature Fₛₕₐₚₑ¹⁰⁻¹′ to the feature F_{id}¹ to acquire a feature Fₛₕₐₚₑ¹⁰; performing a linear transformation on the feature F_{id}¹ to acquire a value of query in the multi-head attention mechanism of the third CAB; performing a linear transformation on the feature Fₛₕₐₚₑ¹⁰ to acquire values of key and value in the multi-head attention mechanism of the third CAB, wherein an output feature Fₛₕₐₚₑ¹¹⁻¹ of the multi-head attention mechanism in the third CAB is acquired; inputting the feature Fₛₕₐₚₑ¹¹⁻¹ into the LayerNorm layer of the third CAB to acquire a feature Fₛₕₐₚₑ¹¹⁻¹′; adding the feature Fₛₕₐₚₑ¹¹⁻¹′ to the feature Fₛₕₐₚₑ¹⁰ to acquire a feature Fₛₕₐₚₑ¹¹; performing a linear transformation on the feature F_{id}¹ to acquire a value of query in the multi-head attention mechanism of the fourth CAB; performing a linear transformation on the feature Fₛₕₐₚₑ¹¹ to acquire values of key and value in the multi-head attention mechanism of the fourth CAB, wherein an output feature Fₛₕₐₚₑ¹²⁻¹ of the multi-head attention mechanism in the fourth CAB is acquired; inputting the feature Fₛₕₐₚₑ¹²⁻¹ into the LayerNorm layer of the fourth CAB to acquire a feature Fₛₕₐₚₑ¹²⁻¹′; and adding the feature Fₛₕₐₚₑ¹²⁻¹′ to the feature Fₛₕₐₚₑ¹¹ to acquire a feature Fₛₕₐₚₑ¹²; and
e-9) constructing the first dilated convolutional block, the second dilated convolutional block, the third dilated convolutional block, the fourth dilated convolutional block, and the fifth dilated convolutional block of the IGSCA module, each comprising a dilated convolutional layer, a group normalization (GroupNorm) layer, and a LeakeyReLU function; inputting the feature Fₛₕₐₚₑ¹² into the dilated convolutional layer of the first dilated convolutional block to acquire a feature Fₛₕₐₚₑ¹³⁻¹, inputting the feature Fₛₕₐₚₑ¹³⁻¹ into the GroupNorm layer of the first dilated convolutional block to acquire a feature Fₛₕₐₚₑ¹³⁻², inputting the feature Fₛₕₐₚₑ¹³⁻² into the LeakeyReLU function of the first dilated convolutional block to acquire a feature Fₛₕₐₚₑ¹³⁻²′, and adding the feature Fₛₕₐₚₑ¹³⁻²′ to the feature Fₛₕₐₚₑ¹² to acquire a feature Fₛₕₐₚₑ¹³; inputting the feature Fₛₕₐₚₑ¹³into the dilated convolutional layer of the second dilated convolutional block to acquire a feature Fₛₕₐₚₑ¹⁴⁻¹ inputting the feature Fₛₕₐₚₑ¹⁴⁻¹ into the GroupNorm layer of the second dilated convolutional block to acquire a feature Fₛₕₐₚₑ¹⁴⁻² inputting the feature Fₛₕₐₚₑ¹⁴⁻² into the LeakeyReLU function of the second dilated convolutional block to acquire a feature Fₛₕₐₚₑ¹⁴⁻²′, and adding the feature Fₛₕₐₚₑ¹⁴⁻²′ to the feature Fₛₕₐₚₑ¹³ to acquire a feature Fₛₕₐₚₑ¹⁴; inputting the feature Fₛₕₐₚₑ¹⁴ into the dilated convolutional layer of the third dilated convolutional block to acquire a feature Fₛₕₐₚₑ¹⁵⁻¹, inputting the feature Fₛₕₐₚₑ¹⁵⁻¹ into the GroupNorm layer of the third dilated convolutional block to acquire a feature Fₛₕₐₚₑ¹⁵⁻², inputting the feature Fₛₕₐₚₑ¹⁵⁻² into the LeakeyReLU function of the third dilated convolutional block to acquire a feature Fₛₕₐₚₑ¹⁵⁻²′, and adding the feature Fₛₕₐₚₑ¹⁵⁻²′ to the feature Fₛₕₐₚₑ¹⁴ to acquire a feature Fₛₕₐₚₑ¹⁵; inputting the feature Fₛₕₐₚₑ¹⁵ into the dilated convolutional layer of the fourth dilated convolutional block to acquire a feature Fₛₕₐₚₑ¹⁶⁻¹, inputting the feature Fₛₕₐₚₑ¹⁶⁻¹ into the GroupNorm layer of the fourth dilated convolutional block to acquire a feature Fₛₕₐₚₑ¹⁶⁻², inputting the feature Fₛₕₐₚₑ¹⁶⁻² into the LeakeyReLU function of the fourth dilated convolutional block to acquire a feature Fₛₕₐₚₑ¹⁶⁻²′, and adding the feature Fₛₕₐₚₑ¹⁶⁻²′ to the feature Fₛₕₐₚₑ¹⁵ to acquire a feature Fₛₕₐₚₑ¹⁶; and inputting the feature Fₛₕₐₚₑ¹⁶ into the dilated convolutional layer of the fifth dilated convolutional block to acquire a feature Fₛₕₐₚₑ¹⁷⁻¹ inputting the feature Fₛₕₐₚₑ¹⁷⁻¹ into the GroupNorm layer of the fifth dilated convolutional block to acquire a feature Fₛₕₐₚₑ¹⁷⁻²,inputting the feature Fₛₕₐₚₑ¹⁷⁻² into the LeakeyReLU function of the fifth dilated convolutional block to acquire a feature Fₛₕₐₚₑ¹⁷⁻²′, and adding the feature Fₛₕₐₚₑ¹⁷⁻²′ to the feature Fₛₕₐₚₑ¹⁶ to acquire the identity and face shape consistency feature F_{ISC}, F_{ISC}∈R⁵¹².

6. The Deepfake detection method based on the identity and the face shape features according to claim 5, wherein
in the step e-3), the 1D convolutional layer of the temporal convolutional block comprises a convolution kernel with a size of 1, a stride of 2, and a padding of 0;
in the step e-4), the 1D convolutional layer of each of the first residual convolutional block, the second residual convolutional block, and the third residual convolutional block comprises a convolution kernel with a size of 1, a stride of 2, and a padding of 0;
in the step e-5), the multi-head attention mechanism of each of the first self-attention block, the second self-attention block, the third self-attention block, and the fourth self-attention block comprises 6 heads;
in the step e-7), the 1D convolutional layer of the identity feature mapping block comprises a convolution kernel with a size of 3, a stride of 1, and a padding of 1;
in the step e-8), the multi-head attention mechanism of each of the first CAB, the second CAB, the third CAB, and the fourth CAB comprises 8 heads; and
in the step c-9), the dilated convolutional layer of each of the first dilated convolutional block and the second dilated convolutional block comprises a convolution kernel with a size of 3, a stride of 1, a padding of 0, and a dilation factor of 2;
the dilated convolutional layer of each of the third dilated convolutional block, the fourth dilated convolutional block, and the fifth dilated convolutional block comprises a convolution kernel with a size of 3, a stride of 1, a padding of 0, and a dilation factor of 4; and
the GroupNorm layer of each of the first dilated convolutional block, the second dilated convolutional block, the third dilated convolutional block, the fourth dilated convolutional block, and the fifth dilated convolutional block has a group size of 16.

7. The Deepfake detection method based on the identity and the face shape features according to claim 3, wherein the step f) comprises:
f-1) inputting the facial identity feature F_{id}ⁿ into the fusion unit of the identity feature consistency network; and calculating, by a torch.mean( ) function in PyTorch, a mean of the facial identity feature F_{id}ⁿ to acquire an identity feature F_{id}²,F_{id}²∈R⁵¹²; and
f-2) concatenating, by a torch.concat( ) function in PyTorch, the identity feature F_{id}² with the identity and face shape consistency feature F_{ISC} to acquire the feature F_{IC}.

8. The Deepfake detection method based on the identity and the face shape features according to claim 2, wherein the step g) comprises:
g-1) calculating the loss function L by L=ηL_{sid}+λL(ƒ_{emb}) wherein η and λ are scaling factors; L_{sid} denotes an embedding optimization loss of a fake identity; L(ƒ_{emb}) denotes a supervised contrastive learning loss;
$${L}_{sid} = \frac{1}{{N}_{F}} 1 \{ {y}_{i}^{s} = {y}_{j}^{s} \} {\sum }_{i ∈ {N}_{F}} δ ( {F}_{id}^{i} , {F}_{id}^{j} ) - \frac{1}{{N}_{R}} 1 \{ {y}_{i}^{s} = {y}_{j}^{s} \} {\sum }_{i ∈ {N}_{R}} δ ( {F}_{id}^{i} , {F}_{id}^{j} ) ;$$
$$1 \{ {y}_{i}^{s} = {y}_{j}^{s} \}$$
indicates that a value of 1 is taken when yᵢ^{s} equals yⱼ^{s} and a value of 0 is taken when yᵢ^{s} is not equal to yⱼ^{s}; yᵢ^{s} denotes a source identity label of an i-th image frame X, , i ∈{1, . . . ,L}; δ(·,·) denotes the cosine similarity calculation function; F_{id}ⁱ denotes a facial identity feature of an i-th video Vᵢ in the training set, i ∈{1, . . . , N}; and F_{id}^{j} denotes a facial identity feature of a j-th video Vⱼ in the training set, j ∈{1, . . . , N}; and
g-2) training, by an adaptive moment estimation (Adam) optimizer, the identity feature consistency network through the loss function L to acquire the optimized identity feature consistency network.

9. The Deepfake detection method based on the identity and the face shape features according to claim 8, wherein η is 0.2, and λ is 0.8.

10. The Deepfake detection method based on the identity and the face shape features according to claim 1, wherein in the step h), τ∈(0,1).
